(19) United States
(12) Patent Application Publication
(10) Pub. No.: US 2020/0386716 A1
(43) Pub. Date: Dec. 10, 2020

(54) METHOD AND APPARATUS FOR EVALUATION OF ACOUSTIC ABSORBERS

(71) Applicant: JUN YANG, LONDON (CA)

(72) Inventors: JUN YANG, LONDON (CA); XIAOBING CAI, LONDON (CA)

(21) Appl. No.: 16/528,833

(22) Filed: Aug. 1, 2019

(30) Foreign Application Priority Data
Jun. 4, 2019 (CN) 201910481537.7

(51) Int. Cl. G01N 29/09; G01N 29/22

(52) U.S. Cl. CPC G01N 29/09; G01N 2291/018; G01N 29/223

(57) ABSTRACT

Provided herein is an acoustic testing method to evaluate the acoustic absorptivity of submicron/nano materials using small samples. Based on the transfer-matrix algorithm, the method establishes correlations among acoustic-related parameters of a large sensor fixture and a small sample holder. We developed a proof-of-principle experimental setup to test absorbers with well-known acoustic behavior to verify accuracy of the method. Finally, we characterize the sound absorption properties of two submicron materials, with one comprising dispersed silver submicron fibers and the other comprising electrospinning submicron fibers. Our results indicate acoustic absorption coefficients can be effectively retrieved using only 1/200 of the amount of materials that are typically required in the standard test.

### FIELD

This disclosure relates to acoustics, particularly relates to a method and an apparatus to measure acoustic properties of porous materials with submicron structures.

### BACKGROUND

In recent years, public concern with respect to noise pollution has grown, which has in turn stimulated the development of acoustic materials for reducing undesired noises. Meanwhile, due to the significant advancement in microfabrication and nanofabrication technologies and material engineering, many materials with submicron scale or nanoscale features have been developed and found their applications in acoustics, and more specifically, in acoustic absorption. Conventional experimental characterization of a submicron materials' acoustic absorbing properties usually requires bulky samples to carry out standard tests. An issue is that the synthesis and fabrication of many submicron materials is expensive and time-consuming. For example, using the impedance tube method, samples of acoustic absorbers are prepared as disks with the diameter and thickness in the tens of millimeters. Therefore, considerable quantities of submicron materials are needed to carry out adequate and meaningful tests, which can be an obstacle for researchers. Furthermore, some acoustic absorption experiments can only be carried out in high frequency regions where smaller samples are required. For example, studying the sound absorption of nanometer scale structures of a moth wing, only the sound absorption coefficients of the moth wing at high frequency ranges can be measured, because the moth wing is very rare.

Thus, there is a need for a cost-effective system to determine the sound absorptivity of materials with a submicron scale or nanoscale structure.

### SUMMARY

The present disclosure provides a new acoustic testing method and apparatus for determining the sound absorptivity of a material that uses approximately 1/200 of the amount of the material compared to the standard impedance tube testing method. More specifically, the present disclosure provides an improved impedance tube method which applies a transfer matrix method to map sound waves recorded by a large sensor fixture to a submicron material sample in a sample holder. In the present method disclosed herein the sound absorbing properties of a sample in the holder were determined from the acoustic responses measured in a large impedance tube. Thus, this approach enables the acoustic absorptivity of a submicron material to be determined with a small fraction of the material compared to that typically used in the standard testing method.

The present disclosure provides a method for determining at least one acoustic property of a porous material using an acoustic impedance tube having a sound source and at least one sensor, and a primary small sample holder attached to the impedance tube, comprising:

positioning a sample of the porous material in the primary small sample holder;

generating sound in the impedance tube, so the sound penetrates into the primary small holder through an opening of the small holder and determining the acoustic impedance Z₃ at a reference plane in the impedance tube away from the opening using the at least one sensor;

determining complex characteristic impedance Z_{eff} and wavenumber k_{eff} of a space between the reference plane and the opening;

using the impedance Z_{eff}, wavenumber k_{eff}, and the acoustic impedance at the reference plane to determine the acoustic impedance at the opening;

determining the at least one acoustic property from the acoustic impedance at the opening; and

wherein the primary small sample holder has a smaller cross-sectional area than the impedance tube, and there is a space between the reference plane and the opening having a length l₂.

The reference plane may be between the sensor and the opening.

The impedance Z_{eff}, and wavenumber k_{eff} may be determined using a transfer-matrix algorithm.

The impedance Z_{eff}, and wavenumber k_{eff} may be determined before positioning the porous sample in the primary small sample holder through the opening of the small sample holder.

The impedance Z_{eff}, and wavenumber k_{eff} may be determined numerically.

The impedance Z_{eff}, and wavenumber k_{eff} may be determined experimentally.

The impedance Z_{eff}, and wavenumber k_{eff} may be determined in a process comprising:

attaching a first small sample holder having a length l′, and the same cross-section as the primary small sample holder to the impedance tube without a sample therein;

generating sound in the impedance tube and determining the acoustic impedance Z₃′ at the reference plane using the at least one sensor and determining the acoustic impedance Z₄′ at the opening;

attaching a second small sample holder having a length l″, and the same cross-section as the primary small sample holder to the impedance tube without a sample therein;

generating sound in the impedance tube and determining the acoustic impedance Z₃″ at the reference plane using the at least one sensor and determining the acoustic impedance Z_{4″} at the opening; and

determining the complex characteristic impedance Z_{eff} and wavenumber k_{eff} using Z₃′, Z₄′, Z₃″ and Z₄″.

One of the first small sample holder and the second small sample holder may be the primary small sample holder.

The primary small sample holder may be the only small sample holder and the other of the first small sample holder and the second small sample holder may have a length of zero.

The primary small sample holder may have an end correction and the length l₂ is greater than the end correction.

The at least one sensor may be spaced from the reference plane by a length equal to length l₂.

The cross-section of the impedance tube may be circular with a diameter D, and the cross-section of the primary small sample holder may be circular with a diameter d.

The length l₂ may be greater than the Rayleigh end correction

$${l}_{2} > \frac{4 d}{3 π} .$$

The length l₂ may be equal to the diameter of the cross-section of the small sample holder.

The at least one sensor may comprise a first microphone configured to measure a first parameter and a second microphone may be configured to measure a second parameter, where the first parameter is acoustic pressure inside the impedance tube at a first location x₁ and the second parameter p₂ is acoustic pressure inside the impedance tube at a second location x₂.

The at least one acoustic property may be one of the acoustic absorbing coefficient or the acoustic reflection coefficient.

The cross-section of the space between the reference plane and the opening may be gradually reducing.

The present disclosure provides an apparatus for acquiring at least one acoustic property comprising:

an acoustic impedance tube having a uniform cross-section, a first end and a second end, a sound source attached to the first end, and at least one sensor;

a sample holder having a front surface, a rigid end, a small sample holder having a uniform cross-section and an opening through the front surface connecting to the small sample holder;

the sample holder being attached to the second end of the impedance tube such that the front surface closes the second end; wherein

the small sample holder has a smaller cross-sectional area than the impedance tube.

The sample holder may be removable to the impedance tube.

The sample holder may be integrated to the impedance tube.

The sample holder may comprise:

a tube segment having a uniform cross-section with a rigid back, the cross-section of the tube section being the same as the cross-section of the impedance tube; and

a small sample adapter having a first end, a second end and a hole from the first end to the second end, the small sample adapter being shaped to fit inside the tube segment, where one of the first end and the second end is positioned against the rigid back and the other of the first end and the second end is the front face, the hole is the small sample holder and the rigid end is the area of the rigid back that closes the small sample holder.

The sample holder may be a single component having a flat surface with a hole having a uniform cross-section therein, the flat surface being the front surface, the hole being the small sample adapter.

The impedance tube may have a circular cross-section of diameter D, and the small sample holder may have a circular cross-section of diameter d.

A further understanding of the functional and advantageous aspects of the present disclosure can be realized by reference to the following detailed description and drawings.

### BRIEF DESCRIPTION OF THE DRAWINGS

Embodiments will now be described, by way of example only, with reference to the drawings, in which:

FIG. 1 is a longitudinal cross-sectional view of a typical impedance tube according to prior art;

FIG. 2 is a longitudinal cross-sectional view of an apparatus for measuring sound absorption of a material according to a preferred embodiment of this invention; and

FIG. 3 is a schematic diagram to illustrate the procedure to determine the sound absorption of the small sample from the acoustic quantities in the large impedance tube.

### DETAILED DESCRIPTION

Various embodiments and aspects of the disclosure will be described herein with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the terms “about” and “approximately” are meant to cover variations that may exist in the upper and lower limits of the ranges of values, such as variations in properties, parameters, and dimensions.

As used herein, the phrase “porous material with submicron structures” generally refers to a material comprising of one or more skeletons and a plurality of pores, and many of the skeletons and pores have the dimensions on the scale of micrometers or less than micrometers. Typical porous materials include fibrous materials, when the crosswise (not longitudinal) dimensions of at least a part of the fibers are on scale of micrometers or nanometers, powder formed material, when the sizes of at least a part of the powder particles are on scale of micrometers or nanometers. The dimension and arrangement of pores inside the porous material may be well organized or completely randomly distributed.

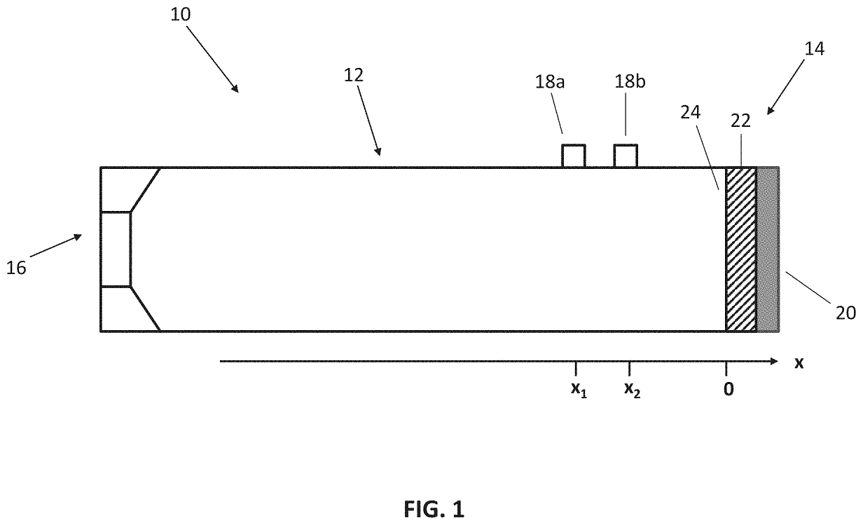

A typical impedance tube is shown in FIG. 1 at 10, generally comprises a straight tube 12 with a sample holder 14 attached to one end, and a sound source 16 attached to the other end. Microphones 18a and 18b attached to the tube 12 at different positions x₁ and x₂ along the longitudinal axis of the tube 12 measured from a reference plane, where x₂ is closer to the reference plane. The microphones 18a and 18b are configured to measure the acoustic pressures p₁ and p₂ inside the tube 12 at positions x₁ and x₂ respectively.

The tube 12 is a waveguide that facilitates the propagation of planar sound waves between the sample holder 14 and the sound source 16. The walls of the tube 12 are sufficiently thick and heavy such that they are not excited by the sound signal.

The sample holder 14 comprises a segment of tube having the same cross-sectional area as the tube 12 and is terminated by a rigid end 20.

In the embodiment of the impedance tube shown in FIG. 1, the sound source 16 is a membrane loudspeaker, but it will be appreciated other sound sources may be used and the present device and method is not restricted to membrane loudspeakers.

The sample 22 is shaped to fit in the sample holder 14 such that sound cannot propagate between the segment of tube in the sample holder 14 and the sample 22. Specifically, the sample 22 has the same cross-section as the sample holder 14 and has a flat front surface 24.

The method of determining the acoustic properties of a sample using a typical impedance tube generally comprises a sample measurement step and a data analysis step.

The sample measurement step is described herein. First, the sample 22 of the material to be studied is positioned inside the sample holder 14 such that the front surface 24 is adjacent to the tube 12. Then the impedance tube 10 is sealed such that it is airtight. In this method, the reference plane is the front surface 24 of the sample 22. Then, the sound source 16 generates sound waves that propagate through the tube 12 as plane waves until they reach the sample 22 where a fraction of the wave is reflected. The reflected waves interfere with the incident waves to form standing waves. While the sound source 16 is generating sound waves, the pressures p₁ and p₂ at locations x₁ and x₂ are measured by microphones 18a and 18b respectively. Additionally, the waveform emitted by the sound source 16 is recorded.

The purpose of the data analysis step is to determine the acoustic reflection coefficient using the pressure data and the waveform emitted by the sound source 16. The theoretically predicted pressure at any position in the tube 12 is given by Eq. 1.

p(x)=Ae^{jkx}+Be^{-jkx} (1)

where the term with amplitude A is the incident wave, the term with amplitude B is the reflected component, j is the imaginary unit, k is the wavenumber, and x is the longitudinal position with respect to the reference plane. The transfer function H₁₂ relates the total pressure at x₁ to the total pressure at x₂ and can be used to equate the theoretically predicted pressures with the experimentally determined measures, as shown in Eq. 2.

$${H}_{12} = \frac{{p}_{2}}{{p}_{1}} = \frac{{e}^{j k {x}_{2}} + {re}^{- j k {x}_{2}}}{{e}^{j k {x}_{1}} + {re}^{- j k {x}_{1}}} \qquad ( 2 )$$

Since the positions x₁ and x₂ are constant and the wavenumber is known, Eq. 2 can be rearranged to isolate for r, as shown in Eq. 3.

$$r = \frac{{e}^{- j k {x}_{2}} - {H}_{12} {e}^{- j k {x}_{1}}}{{H}_{12} {e}^{j k {x}_{1}} - {e}^{j k {x}_{2}}} \qquad ( 3 )$$

Once the reflection coefficient r is known, the absorption coefficient α can be determined using Eq. 4.

α=1−|r|² (4)

Since the reference plane is located at the front surface 24, the reflection and absorption coefficients of the reference plane are the same as that of the sample 22. The acoustic impedance Z₃ at the reference plane can be determined using the acoustic reflection coefficient and the acoustic impedance Z₀ in the tube 12, as given by Eq. 5.

$${Z}_{3} = {Z}_{0} \frac{1 + r}{1 - r} \qquad ( 5 )$$

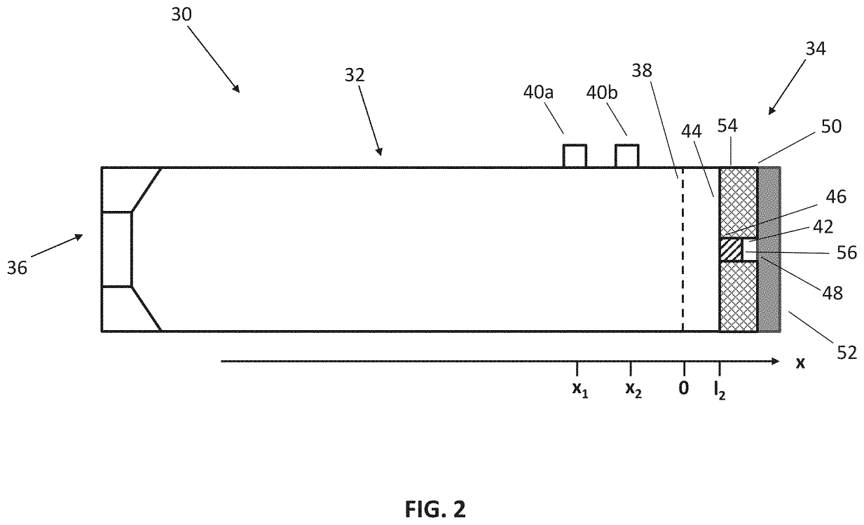

The improved impedance tube of the present disclosure, an embodiment of which is shown in FIG. 2 at 30, generally comprises a tube 32 with a sample holder 34 attached to one end, and a sound source 36 attached to the other end. A sensor is configured to measure the pressures p₁ and p₂ at different positions x₁ and x₂ along the longitudinal axis with respect to a reference plane 38, where x₂ is closer to the reference plane 38.

The tube 32 is a waveguide that facilitates the propagation of planar sound waves between the sample holder 34 and the sound source 36. The cross-sectional area of the tube 32 is denoted by A_{T}.

In the embodiment of the disclosure shown in FIG. 2, the sound source 36 is a membrane loudspeaker.

In the embodiment of the disclosure shown in FIG. 2, the sensor is a pair of microphones 40a and 40b which are attached to the wall of the tube 32 at positions x₁ and x₂ respectively and are configured to measure the pressures p₁ and p₂.

In an alternate embodiment of the disclosure, the sensor comprises more than two microphones to provide more than two pressure measurements at additional positions.

The sample holder of the present disclosure, an embodiment of which is shown in FIG. 2 at 34, generally comprises small sample holder 42, a flat front surface 44 having an opening 46 which connects the tube 32 to the small sample holder 42, and a rigid end 48 which terminates the small sample holder 42. The small sample holder 42 has a uniform cross-sectional area, A_{H}, that is smaller than the cross-sectional area, A_{T}, of the tube 32. The sum of the surface area of the front surface 44 and the cross-sectional area, A_{H}, of the small sample holder 42 is equal to the cross-sectional area, A_{T}, of the tube 32. The length of the small sample holder 42 is denoted by l and is the depth from the front surface 44 to the rigid end 48.

In the embodiment of the present disclosure shown in FIG. 2, the sample holder 34 comprises a tube segment 50 having the same cross-section as the tube 32, terminated by a rigid back 52, and has a small sample adapter 54. The small sample adapter 54 is shaped such that sound cannot propagate between the segment of tube 50 in the sample holder 34 and the small sample adapter 54. Specifically, the small sample adapter 54 has the same cross-section as the sample holder 34 and has a planar front that is the front surface 44. The small sample holder 42 is a cavity in the small sample adapter 54. The small sample holder 42 opens into the tube 32 through the opening 46 and the rigid end 48 is the portion of the rigid back 52 that closes the small sample holder 42.

In the embodiment of the disclosure shown in FIG. 2, the impedance tube 30 is a typical impedance tube such as the one shown in FIG. 1 with the addition of a small sample adapter. In a preferred embodiment, the typical impedance tube adheres to the specifications of ISO 10534-2.

In a further embodiment of the present disclosure, both of the sides of the small sample adapter are flat such that either one of the two sides may be positioned in the sample holder as the front side.

In the embodiment of the present disclosure shown in FIG. 2, the tube 32 has a circular cross-section of diameter D such that the cross-sectional area, A_{T} is

$${π ( \frac{D}{2} )}^{2} ,$$

and the small sample holder 42 has a circular cross-section of diameter d such that the cross-sectional area, A_{H} is

$${π ( \frac{d}{2} )}^{2} .$$

Additionally, the longitudinal axes of the tube 32 and the small sample holder 42 coincide. In a preferred embodiment, diameter D is 60 mm and diameter d is 4 mm.

In the embodiment of the present disclosure shown in FIG. 2, the sample 56 has the same cross-section as the small sample holder 42 and has a flat front surface that is coincident with the front surface 44 of the sample holder 34.

In an alternate embodiment of the present disclosure, the sample holder is a single component made out of a rigid material. The flat front surface is a planar surface on the sample holder and the small sample holder is a cavity having a uniform cross-sectional area in the flat front surface. The small sample holder does not extend through the sample holder so the rigid end is the flat surface of the sample holder which terminates the cavity.

In an alternate embodiment of the present disclosure, the front surface is a truncated cone where the base of the cone has the same cross-section as the impedance tube and the opening of the small sample holder is the tip of the truncated cone. In the present embodiment, the cross-sectional area gradually decreases from the base of the truncated cone to the tip of the truncated cone.

The method for determining the acoustic properties of a material using a typical impedance tube is not compatible with the impedance tube of the present disclosure because the front surface does not have uniform acoustic properties. Specifically, the tube is not terminated by a flat material with uniform acoustic properties since the front surface and the sample have different acoustic properties and the front surface is not flat due to the opening. Therefore, the reference plane must be spaced from the front surface toward the sound source by a distance of l₂.

In an embodiment of the present disclosure, the reference plane is located between the front face of the sample holder and the microphone x₂. In a further preferred embodiment, the cross-section of the small sample holder has an end correction and the position of the reference plane to the interior face, l₂, is greater than the end correction. In a further preferred embodiment, the position of the nearest microphone relative to the reference plane is equal to the distance between the reference plane and the front surface, x₂=−l₂.

In a preferred embodiment where the tube and the small sample holder have circular cross-sections, the position of the reference plane to the interior face l₂ is greater than the Rayleigh end correction l₂>4d/3π, preferably l₂=d.

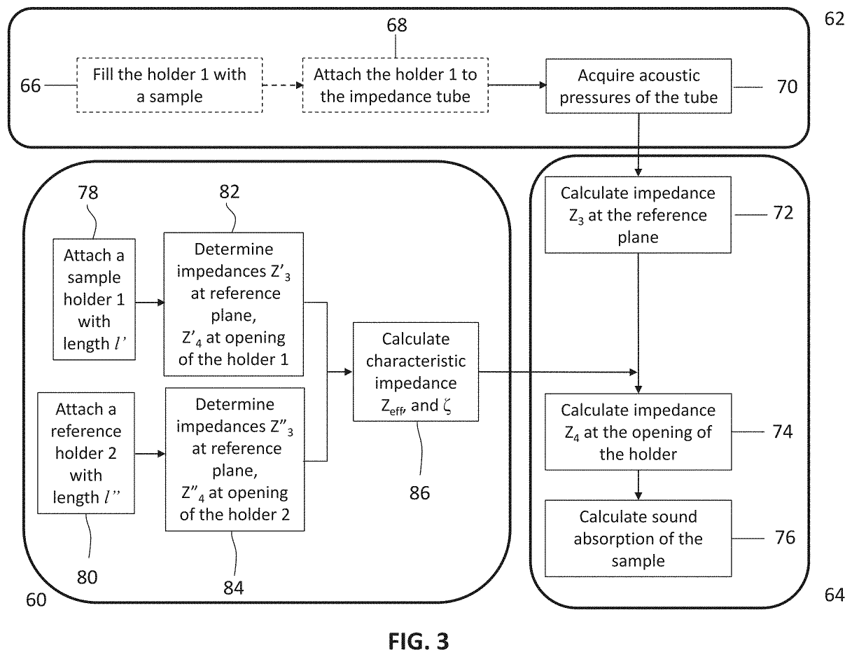

The method of determining the acoustic properties of a sample using an impedance tube, an embodiment of which is shown in FIG. 3, generally comprises a calibration step 60, a sample measurement step 62, and a data analysis step 64.

The sample measurement step 62 is described herein. First, a sample 56 of the material to be studied is positioned inside the small sample holder 42 such that the front surface coincides with the front surface 44 and there is a gap between the sample 56 and the rigid end 48, shown at 66. Then the impedance tube 30 is sealed such that it is airtight, shown in 68. Then, the acoustic information is acquired 70, where the sound source 36 generates sound waves that propagate through the tube 32 as plane waves until they reach the sample 56 where a fraction of the waves are reflected. The reflected waves interfere with the incident waves to form standing waves. While the sound source 36 is generating sound waves, the pressures p₁ and p₂ at locations x₁ and x₂ are measured by microphones 38a and 38b respectively. Additionally, the sound signal emitted by the sound source 36 is recorded.

In a preferred embodiment of the sample measurement step of the present disclosure, the ambient temperature and pressure are recorded.

The data analysis step of the present disclosure is described herein. First, the transfer function, Eq. 2 is evaluated using the experimentally determined pressure data from microphones 38a and 38b in the measurement step. Then, the transfer function is substituted into Eq. 3 to determine the acoustic reflection coefficient at the reference plane, which is then substituted into Eq. 5 to determine the acoustic impedance at the reference plane, as shown at 72.

In the embodiment of the data analysis step of the present disclosure, a transfer-matrix method is used to determine the acoustic impedance at the front surface 42. The region of the tube 32 between the reference plane and the front surface 42 is an effective medium possessing complex characteristic impedance Z_{eff} and k_{eff}. Therefore, the average sound pressure and velocity (p₄, v₄) at the front surface 42 can be determined given the average sound pressure and velocity (p₃, v₃) at the reference plane using the transfer-matrix method, Eq. 6.

$$[ \begin{matrix}{p}_{3} \\ {v}_{3}\end{matrix} ] = [ \begin{matrix}cos ( {k}_{eff} {l}_{2} ) & j {Z}_{eff} sin ( {k}_{eff} {l}_{2} ) \\ \frac{j}{{Z}_{eff}} sin ( {k}_{eff} {l}_{2} ) & cos ( {k}_{eff} {l}_{2} )\end{matrix} ] [ \begin{matrix}{p}_{4} \\ {v}_{4}\end{matrix} ] \qquad ( 6 )$$

The transfer-matrix, Eq. 6 can then be rearranged to give Eq. 7, which relates the impedance Z₃ at the reference plane to the impedance Z₄ at the front surface 42:

ζ(Z₃Z₄−Z_{eff}²)=Z_{eff}(Z₄−Z₃), (7)

where ζ=j tan(k_{eff} l₂),

$${Z}_{3} = \frac{{p}_{3}}{{v}_{3}} and {Z}_{4} = \frac{{p}_{4}}{{v}_{4}} .$$

p₃, v₃, p₄ and v₄ obtained either experimentally or numerically. Denoting the cross-sectional areas of the tube 32 and the small sample holder 42 as A_{T} and A_{H} respectively, for a specific set of A_{T}, A_{H} and l₂, Z_{eff} and ζ should be constant as they are the effective properties of the intermediate space between the reference plane and the front surface 42. Therefore, Z_{eff} and ζ can be determined independently in the calibration phase. If Z_{eff} and ζ are known, then Z₄ can be determined from Eq. 7 to give Eq. 8, shown at 74.

$${Z}_{4} = \frac{{ζZ}_{eff}^{2} - {Z}_{3} {Z}_{eff}}{ζ {Z}_{3} - {Z}_{eff}} \qquad ( 8 )$$

Once Z₄ is known the acoustic reflection coefficient of the sample 56 and the acoustic absorption coefficient can be determined using Eq. 9 and Eq. 4 respectively, as shown at 76.

$$r = \frac{{Z}_{4} - {Z}_{0}}{{Z}_{4} + {Z}_{0}} \qquad ( 9 )$$

The purpose of the calibration phase 60 is to determine the values of Z_{eff} and ζ for a specific set of A_{T}, A_{H} and l₂. Z_{eff} and ζ are determined by repeating the sample measurement step on a first 78 and second 80 sample holders having lengths l′ and l″ respectively, without a sample in either of the first or second sample holders. Then, the pressure measurements are used to determine Z₃′, Z₃″, Z₄′ and Z₄″, shown at 82 and 84 respectively. Then, Z₃′ and Z₄′, and Z₃″ and Z₄″ can be substituted into Eq. 5 to yield a first equation and second equation respectively. Then, the first and second equations are combined to eliminate one of Z_{eff} and ζ, and the remaining unknown constant is determined, as shown at 86.

In a preferred embodiment of the calibration step, the intermediate relationship given by Eq. 10 is used to eliminate the unknown constant ζ which allows Z_{eff} to be isolated as shown in Eq. 11.

$$\begin{matrix}{Z}_{T} = \frac{{Z}_{{4}^{′}} - {Z}_{{3}^{′}}}{{Z}_{{4}^{″}} - {Z}_{{3}^{″}}} & ( 10 ) \\ {Z}_{eff}^{2} = \frac{{z}_{{T}^{{Z}_{{3}^{″}} {Z}_{{4}^{″}} - {Z}_{{3}^{′}} {Z}_{{4}^{′}}}}}{{Z}_{T} - 1} & ( 11 )\end{matrix}$$

Once Z_{eff} is known then it can be substituted back into Eq. 7 and solved using either Z₃′ and Z₄′, or Z₃″ and Z₄″.

In the embodiment of the present disclosure where the cross-section of the small sample holder is circular, Z₄a′ and Z₄″ are determined using an Eq. 12, which relates cross-section and length of the small sample holder to the impedance at the opening.

$${Z}_{4} = - j {Z}_{0} \frac{{A}_{T}}{{A}_{H}} {tan}^{- 1} ( - j k l ) \qquad ( 12 )$$

In an embodiment of the calibration phase, the complex characteristic impedance Z_{eff} and wavenumber k_{eff} are determined before the sample measurement phase.

In a further preferred embodiment, the one of the first and second small sample holders has a length of zero and the other of the first and second holders having a real length is used in the sample measurement phase such that only one small sample holder is used.

While the proposed method described herein is in conjunction with various embodiments for illustrative purposes, it is not intended that the proposed method be limited to such embodiments. On the contrary, the proposed method described and illustrated herein encompass various alternatives, modifications, and equivalents, without departing from the embodiments, the general scope of which is defined in the appended claims.

Except to the extent necessary or inherent in the processes themselves, no particular order to steps or stages of methods or processes described in this disclosure is intended or implied. In many cases the order of process steps may be varied without changing the purpose, effect, or import of the methods described.

What is claimed is:

1. A method for determining at least one acoustic property of a porous material using an acoustic impedance tube having a sound source and at least one sensor, and a primary small sample holder attached to the impedance tube, comprising:
positioning a sample of the porous material in the primary small sample holder;
generating sound in the impedance tube, so the sound penetrates into the primary small holder through an opening of the small holder and determining the acoustic impedance Z₃ at a reference plane in the impedance tube away from the opening using the at least one sensor;
determining complex characteristic impedance Z_{eff} and wavenumber k_{eff} of a space between the reference plane and the opening;
using the impedance Z_{eff}, wavenumber k_{eff}, and the acoustic impedance at the reference plane to determine the acoustic impedance at the opening; and
determining the at least one acoustic property from the acoustic impedance at the opening;
wherein the primary small sample holder has a smaller cross-sectional area than the impedance tube, and there is a space between the reference plane and the opening having a length l₂.

2. The method of claim 1, wherein the reference plane is between the sensor and the opening.

3. The method of claim 1, wherein the impedance Z_{eff}, wavenumber k_{eff} are determined using a transfer-matrix algorithm.

4. The method of claim 1, wherein the impedance Z_{eff}, wavenumber k_{eff} are determined before positioning the porous sample in the primary small sample holder through the opening of the small sample holder.

5. The method of claim 1, wherein the impedance Z_{eff}, wavenumber k_{eff} are determined numerically.

6. The method of claim 1, wherein the impedance Z_{eff}, wavenumber k_{eff} are determined experimentally.

7. The method of claim 1, wherein the-impedance Z_{eff}, wavenumber k_{eff} are determined in a process comprising:
attaching a first small sample holder having a length l′, and the same cross-section as the primary small sample holder to the impedance tube without a sample therein;
generating sound in the impedance tube and determining the acoustic impedance Z₃′ at the reference plane using the at least one sensor and determining the acoustic impedance Z₄′ at the opening;
attaching a second small sample holder having a length l″, and the same cross-section as the primary small sample holder to the impedance tube without a sample therein;
generating sound in the impedance tube and determining the acoustic impedance Z₃″ at the reference plane using the at least one sensor and determining the acoustic impedance Z₄″ at the opening; and
determining the complex characteristic impedance Z_{eff} and wavenumber k_{eff} using Z₃′, Z₄′, Z₃″ and Z₄″.

8. The method of claim 7, wherein one of the first small sample holder and the second small sample holder is the primary small sample holder.

9. The method of claim 8, wherein the primary small sample holder is the only small sample holder and the other of the first small sample holder and the second small sample holder has a length of zero.

10. The method of claim 1, wherein the primary small sample holder has an end correction and the length l₂ is greater than the end correction.

11. The method of claim 1, wherein the at least one sensor is spaced from the reference plane by a length equal to length l₂.

12. The method of claim 1, wherein the cross-section of the impedance tube is circular with a diameter D, and the cross-section of the primary small sample holder is circular with a diameter d.

13. The method of claim 12, wherein the length l₂ is greater than the Rayleigh end correction
$${l}_{2} > \frac{4 d}{3 π} .$$

14. The method of claim 13, wherein the length l₂ is equal to the diameter of the cross-section of the small sample holder.

15. The method of claim 1, wherein the at least one sensor comprises a first microphone configured to measure a first parameter and a second microphone configured to measure a second parameter, where the first parameter is acoustic pressure inside the impedance tube at a first location x₁ and the second parameter p₂ is acoustic pressure inside the impedance tube at a second location x₂.

16. The method of claim 1, wherein the at least one acoustic property is one of the acoustic absorbing coefficient or the acoustic reflection coefficient.

17. The method of claim 1, wherein the cross-section of the space between the reference plane and the opening is gradually reducing.

18. An apparatus for acquiring at least one acoustic property comprising:
an acoustic impedance tube having a uniform cross-section, a first end and a second end, a sound source attached to the first end, and at least one sensor;
a sample holder having a front surface, a rigid end, a small sample holder having a uniform cross-section and an opening through the front surface connecting to the small sample holder;
the sample holder being attached to the second end of the impedance tube such that the front surface closes the second end; wherein
the small sample holder has a smaller cross-sectional area than the impedance tube.

19. The apparatus of claim 18, wherein the sample holder is removable to the impedance tube.

20. The apparatus of claim 18, wherein the sample holder is integrated to the impedance tube.

21. The apparatus of claim 18, wherein the sample holder comprises:
a tube segment having a uniform cross-section with a rigid back, the cross-section of the tube section being the same as the cross-section of the impedance tube;
a small sample adapter having a first end, a second end and a hole from the first end to the second end, the small sample adapter being shaped to fit inside the tube segment, where one of the first end and the second end is positioned against the rigid back and the other of the first end and the second end is the front face, the hole is the small sample holder and the rigid end is the area of the rigid back that closes the small sample holder.

22. The apparatus of claim 18, wherein the sample holder is a single component having a flat surface with a hole having a uniform cross-section therein, the flat surface being the front surface, the hole being the small sample adapter.

23. The apparatus of claim 18, wherein the impedance tube has a circular cross-section of diameter D, and the small sample holder has a circular cross-section of diameter d.
